(19) United States
(12) Patent Application Publication
(10) Pub. No.: US 2026/0356600 A1
(43) Pub. Date: Nov. 12, 2026

(54) AUTOMATED MAIL TRANSPORT EQUIPMENT SORTATION AND STACKING SYSTEMS AND METHODS THEREOF

(71) Applicant: Amentum Services, Inc, Chantilly, VA (US)

(72) Inventors: Benjamin Sherwood, Chantilly, VA (US); Thomas Treffinger, Chantilly, VA (US)

(21) Appl. No.: 19/674,948

(22) Filed: May 12, 2026

Related U.S. Application Data
(60) Provisional application No. 63/804,596, filed on May 12, 2025.

(51) Int. Cl. B65G 47/90; B07C 5/34; B65B 11/04; B65B 35/50; B65C 9/46; B65G 47/16; B65G 61/00

(52) U.S. Cl. CPC B65G 47/90; B07C 5/3404; B65B 11/04; B65B 35/50; B65C 9/46; B65G 47/16; B65G 61/00; B65G 2201/0258; B65G 2201/0285; B65G 2203/0216; B65G 2203/041

(57) ABSTRACT

An automated system for separating mail transport equipment (MTE) includes a receiving parcel belt conveyor onto which MTE is deposited and a plurality of additional parcel belt conveyors arranged in series, with each additional parcel belt conveyor angled relative to one another at a predetermined angle. A sortation conveyor receives the MTE from the additional parcel belt conveyors and further separates and sorts the MTE onto a plurality of sorting line conveyors, each configured to receive a predetermined size of MTE. A scanning device can determine whether a conveyed MTE includes unapproved material thereon. A plurality of picking robots, each assigned to a respective sorting line conveyor, can pick up a single MTE and stack the MTE on a plurality of stacking stations. A plurality of stacking station conveyors can transport stacks of MTE from the stacking stations to an outflow conveyor.

### CROSS-REFERENCE TO RELATED APPLICATIONS

This application claims the benefit of and priority to U.S. Provisional Application No. 63/804,596, filed May 12, 2025, the entire contents of which are incorporated herein by reference.

### TECHNICAL FIELD

The disclosure relates generally to systems and techniques for a content transport system within an establishment such as, a factory, or a distribution center, and in particular to automated mail transport equipment sortation systems.

### BACKGROUND

Mail transport equipment service center operations are generally manual and labor-dependent, especially within the product inspection process. As a result, a lack of proficient and reliable employees available for performing various manual tasks associated with the mail transport equipment service center operations makes operating the mail transport equipment service center increasingly difficult. Additionally, there are substantial costs associated with employee attendance issues, significant challenges such as absenteeism, tardiness, injuries, employee retention/recruiting/turnover, low efficiency (e.g., during initial training periods with new employees), etc.

### BRIEF DESCRIPTION OF THE DRAWINGS

Illustrative aspects of the present application are described in detail below with reference to the following figures:

FIG. 1 illustrates a top, plan view of an automated system for separating mail transport equipment, in accordance with aspects of this disclosure;

FIG. 2 illustrates a side view of an MTE separation section of the automated system for separating mail transport equipment of FIG. 1, in accordance with aspects of this disclosure.

FIGS. 3A-3B illustrate a plan view of another automated system for separating mail transport equipment, in accordance with aspects of this disclosure;

FIG. 4 illustrates an example bulk product subsystem, in accordance with aspects of the present disclosure;

FIGS. 5A-B illustrate an example infeed subsystem, in accordance with aspects of the present disclosure;

FIGS. 6A-B illustrates an example outfeed subsystem, in accordance with aspects of the present disclosure;

FIG. 7 illustrates an example palletization subsystem, in accordance with aspects of the present disclosure;

FIGS. 8A-8B illustrate another automated MTE separation system, in accordance with aspects of this disclosure.

FIG. 9 illustrates an alternate arrangement of some subsystems of the automated MTE separation system shown in FIG. 8A, accordance with aspects of this disclosure.

FIG. 10 illustrates a flow-chart of an example method for separating mail transport equipment (MTE) in accordance with some aspects of the present disclosure; and

FIG. 11 illustrates flow chart of another example a method 1100 for separating mail transport equipment, in accordance aspects of this disclosure.

FIG. 12 illustrates an example computing system of an example robot configured to implement various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth to provide a thorough understanding of aspects of the application. However, it will be apparent that various aspects may be practiced without these specific details. The figures and description are not intended to be restrictive.

This disclosure provides automated systems for separating mail transport equipment for reuse and label removal. Mail transport equipment (“MTE”) are the sacks, trays, containers, sleeves, or boxes used to transport mail, parcels, or other small packages and envelopes. Mail transport equipment is often made of cardboard or plastic, though other materials may be used, including fabric or lightweight metal, and may be provided in a variety of sizes and volume. Each MTE is typically flattened and reused. After use, each MTE (e.g., a sleeve, box, sack, etc.) is disposed in a bulk container called a gaylord box or rolling stock container, and then full gaylord boxes and rolling stock containers are then processed manually though inspection, labeling (e.g., removing or covering old labels with a blank label, ink, or other cover), sorting, and palletization operations that require manual labor at each step in the process.

The automated system for separating mail transport equipment of this disclosure enables faster processing of the MTE from the gaylord box or rolling stock container by automatically separating the MTE from a large pile into smaller, manageable individualized lines for faster processing and white-labeling. The automated system includes an alpine conveyors section that separates the MTE in a singulation process using a plurality of parcel belt conveyors arranged relative to each other at predetermined angles that reduces a pile of MTE into smaller piles or individualized units in a singulation process.

An aspect of the present disclosure provides an automated system for separating mail transport equipment. The system includes a receiving parcel belt conveyor onto which mail transport equipment (MTE) is deposited, and a plurality of additional parcel belt conveyors arranged in series, with each of the plurality of additional parcel belt conveyors angled relative to one another at a predetermined angle. A sortation conveyor is provided onto which the MTE is deposited after exiting an end of one of the plurality of additional parcel belt conveyors, and the sortation conveyor is configured to further separate the MTE and sort the MTE. The system further includes a plurality of sorting line conveyors coupled to the sortation conveyor, where each of the sorting line conveyors is configured to receive a predetermined size of MTE conveyed from the sortation conveyor. A scanning device is operable to determine if a conveyed MTE has one or more unapproved material thereon, and a plurality of picking robots is configured to pick up a single one of the conveyed MTE, where each of the plurality of picking robots is assigned to one of the plurality of sorting line conveyors. The system also includes a plurality of stacking stations configured to receive a picked MTE from a respective one of the plurality of picking robots, whereon the conveyed MTE is stacked by the respective one of the plurality of picking robots into stacks of MTE on each of the stacking stations, along with a plurality of stacking station conveyors corresponding to each of the plurality of stacking stations and operable to transport each of the stacks of MTE to an outflow conveyor.

According to another aspect of the present disclosure, an automated system for processing mail transport equipment is provided. The system includes a receiving conveyor configured to receive mail transport equipment deposited from a bulk container; a plurality of parcel belt conveyors arranged in series downstream of the receiving conveyor in an alpine configuration, where at least three parcel belt conveyors of the plurality of parcel belt conveyors are arranged such that at least one of the at least three parcel belt conveyors is oriented as a declining parcel belt conveyor defining a negative angle relative to ground, and where adjacent parcel belt conveyors of the plurality of parcel belt conveyors are operated at different speeds to reduce overlap between adjacent mail transport equipment; a sortation conveyor positioned downstream of the plurality of parcel belt conveyors and configured to direct each mail transport equipment to a selected one of a plurality of sorting line conveyors based on a parameter associated with the mail transport equipment; a plurality of picking robots, each picking robot associated with a respective one of the plurality of sorting line conveyors and configured to pick up a single mail transport equipment from the respective sorting line conveyor; one or more scanning devices positioned to detect whether the mail transport equipment includes unapproved material; a label cancellation system configured to receive mail transport equipment identified as including the unapproved material, the label cancellation system comprising one or more inspection cameras configured to determine a location of the unapproved material and a material covering device configured to cover, obscure, or remove the unapproved material; a return loop coupled to the label cancellation system and configured to return label-cancelled mail transport equipment to one of the plurality of parcel belt conveyors, the sortation conveyor, or one of the plurality of sorting line conveyors for further processing; a plurality of stacking stations, each stacking station associated with a respective one of the plurality of picking robots and configured to receive the mail transport equipment from the respective picking robot to form a stack of mail transport equipment; and an outflow conveyor positioned downstream of the plurality of stacking stations and configured to transport the stack of mail transport equipment toward a palletizing region.

According to another aspect of the present disclosure, a method for separating mail transport equipment is provided. The method includes depositing a mail transport equipment (MTE) onto a parcel belt conveyor; receiving the MTE from the parcel belt conveyor and directing the MTE to two or more pick bins via a plurality of pick conveyors; selecting, by an inspection robot of a plurality of inspection robots, a single MTE from a respective one of the two or more pick bins for inspection; determining a presence of unapproved material on the MTE using a top inspection camera operable to view a top of the MTE or a bottom inspection camera arranged to view an opposite side of the MTE as compared to the top inspection camera; providing a label for the single MTE using a plurality of machines paired with a respective one of the plurality of inspection robots; and sorting, using a sortation conveyor, the single MTE into a stacking area associated with a type of the single MTE.

According to a further aspect of the present disclosure, a method of sorting mail transport equipment (MTE) is provided. The method includes depositing MTE from a bulk container onto at least one receiving conveyor; singulating the MTE by conveying the MTE along a plurality of conveyors arranged in series, where at least two conveyors of the plurality of conveyors are angled relative to one another or operated at different speeds to reduce overlap between adjacent MTE; identifying, by one or more sensors, a type of each singulated MTE; directing, by a multi-directional sortation conveyor, each identified MTE to a respective sorting line conveyor based on the identified type of the MTE; detecting, by one or more scanning devices, whether the MTE includes unapproved material; diverting MTE including the unapproved material to a label cancellation system; covering, obscuring, or removing the unapproved material from the diverted MTE; and stacking sorted MTE from the respective sorting line conveyors at respective stacking stations.

The automated system includes a parcel belt conveyor onto which mail transport equipment (MTE) is deposited from a bulk container; a plurality of pick conveyors operable to receive the MTE from the parcel belt conveyor and direct the MTE to two or more pick bins; a plurality of inspection robots operable to select a single MTE from a respective one of the two or more pick bins for inspection; a top inspection camera operable to view a top of the MTE to determine the presence of unapproved material on the MTE; a bottom inspection camera arranged to view an opposite side of the MTE as compared to the top inspection camera; a plurality of label cancellation machines operable to provide a cover material to cover an existing label of the MTE; and a sortation conveyor operable to sort the single MTE into stacking area associated with a type of the single MTE. The top and bottom inspection cameras may each be operable to determine the presence of unapproved material on the MTE. Each label cancellation machine of the plurality of machines is paired with a respective one of the plurality of inspection robots.

In another aspect, a method for processing mail transport equipment is provided. The method includes depositing a mail transport equipment (MTE) onto a parcel belt conveyor; receiving the MTE from the parcel belt conveyor and directing the MTE to two or more pick bins via a plurality of pick conveyors; selecting, by an inspection robot of a plurality of inspection robots, a single MTE from a respective one of the two or more pick bins for inspection; determining a presence of unapproved material on the MTE using a top inspection camera operable to view a top of the MTE or a bottom inspection camera arranged to view an opposite side of the MTE as compared to the top inspection camera; providing a label for the single MTE using a plurality of machines paired with a respective one of the plurality of inspection robots; and sorting, using a sortation conveyor, the single MTE into stacking area associated with a type of the single MTE.

By leveraging advancements in robotics, vision, and automation systems, the automated content transport system described herein provides a number of advantages over conventional manual operations within a mail transport equipment service center. For example, automating the inspection, labeling, sorting, and palletization operations may reduce reliance on manual labor and thereby mitigate costs associated with absenteeism, tardiness, injuries, turnover, and reduced efficiency during training of new employees. Automating these operations may also reduce worker's compensation exposure, including direct costs and indirect rate impacts that can drive contract labor rates upward. The automated system for separating and handling mail transport equipment increases throughput reliability and predictability within the service center, enabling more consistent production volumes and a cost-controlled operating environment. The automated system may further improve consistency of label cancellation and sortation outcomes by reducing variability associated with manual inspection. While the advantages are described herein with reference to a mail transport equipment service center, similar benefits may be realized in other material or content transport service centers, including those associated with an establishment, a factory, a processing facility, or a distribution center.

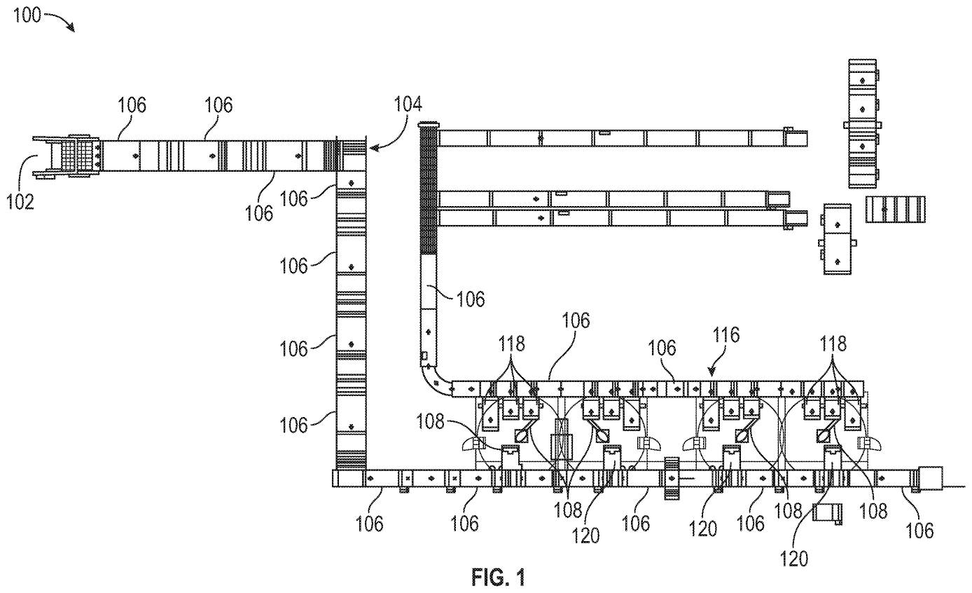

FIG. 1 illustrates an example automated conveyor system 100 for separating and handling mail transport equipment (“MTE”) in accordance with aspects of this disclosure. The automated conveyor system 100 describes an end-to-end robotics and automation system for processing mail transport equipment, such as sleeves, lids, or other parcels or parcel carriers. The automated conveyor system 100 processes the MTE using a dumper 102 that dumps a pile of MTE onto a conveyor system 104 that is operable to separate the pile of MTE. The conveyors system 104 includes a plurality of conveyors 106 arranged to separate and singulate the MTE, and move the MTE toward one or more picker robots 108. The conveyor system 104 may include a receiving conveyor section 110 that receives the MTE from the dumper 102 and conveys the MTE to an MTE separation section 112. The MTE separation section 112 separates the pile of MTE into smaller piles or individual units and passes them along to a singulation and sortation section 114 of the conveyor system 104. The singulation and sortation section 114 operates to perform a final singulation of each MTE and sort each MTE via the one or more picking robots 108 into discrete piles of matching MTE. Each of the receiving conveyor section 110, the MTE separation section 112, and the singulation and sortation section 114 include one or more of the conveyors 106.

The one or more picking robots 108 pickup and drop each MTE into respective sorted piles on a stacking station 118 of an outflow conveyor section 116. Once a sorted pile of MTE reaches a predetermined size or amount, that sorting station conveys the sorted pile onto outflow conveyors, including one or more conveyors 106, that sends the sorted pile of MTE to be wrapped and packaged for delivery to a mail facility for reuse.

The dumper 102 is configured to receive a gaylord or rolling stock container that are filled with MTE and raise the gaylord or rolling stock container at an angle to deposit the MTE onto the conveyor system 104.

The one or more conveyors 106 may be a moving conveyor such as a belt conveyor, roller conveyor, or other similar conveyor system for moving an object from A to B. In aspects, the conveyors 106 are parcel belt conveyors operable to move mail parcel.

The receiving conveyor section 110 may include a plurality of such conveyors 106 in series that may operate at one or more speeds or different speeds from each other to convey the pile of MTE deposited thereon by the dumper 102 to the MTE separation section 112.

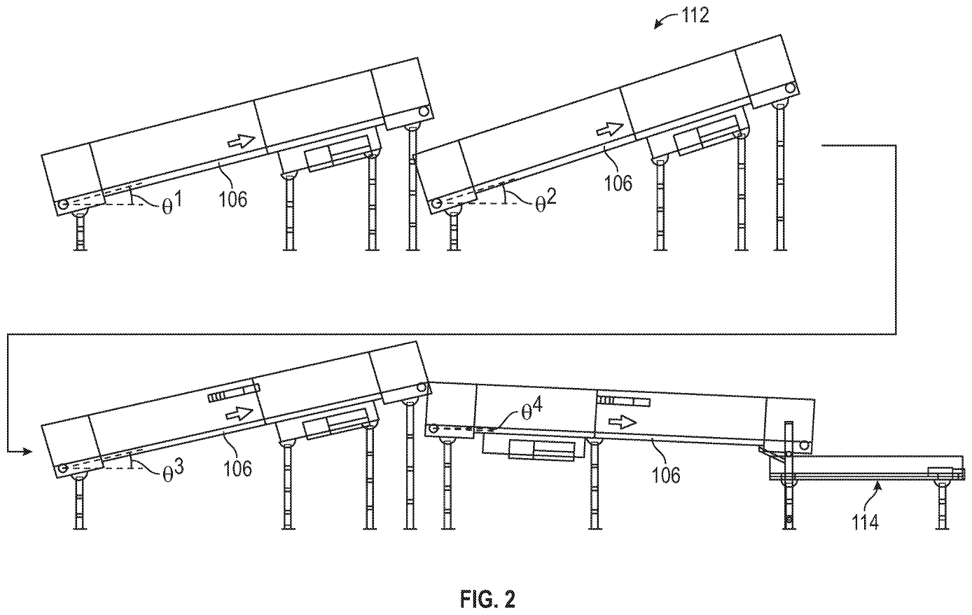

With additional reference to FIG. 2, the MTE separation section 112 includes a plurality of conveyors 106 (e.g., parcel belt conveyors or rollers) laid out in a series of angled positions, either inclined or declined, in different sections such that the MTE is raised and dropped to separate the MTE into smaller piles or individual units. In aspects, each successive conveyor 106 of the MTE separation section 112 is operates a different conveyor speed. In aspects, each successive conveyor 106 may be operated at a higher speed than the speed of the prior conveyor 106. The MTE separation section 112 thereby tumbles the MTE between conveyors 106 wherein each MTE is pushed forward at a higher speed as it is received from the prior conveyor 106. The angled positions enable the MTE to separate as it falls or transitions from one conveyor 106 to the next conveyor 106. As a result, a needed level of separation may be achieved during a first MTE singulation phase.

In aspects, the receiving conveyor section 110 may be referred to as a receiving parcel belt conveyor and the MTE separation section 112 may be referred to as a plurality of additional parcel belt conveyors.

Returning to FIG. 1, in aspects, the conveyors 106 are spaced such that accessory material (e.g., strings, ribbons, plastic wrap, leaves, garbage, and other refuse) are separated from the MTE prior to entry into the next phase of conveyance. In aspects, the conveyors 106 may have a high guard rail to protect the MTE from falling off, wherein the high guard rail may be from about 1 inches to about 24 inches. In aspects, the conveyors 106 may be configured with various grooves or holes to catch the accessory material.

In aspects, from the dumper 102 through the singulation and sortation section 114, the MTE undergoes a “singulation process” where it is separated from a bulk pile into approximately individualized units. Different products exit from the conveyor system 104 to the picking table sections 120 at different locations based upon the size and/or weight of the products. In aspects, the variously sized MTE is separated by type and size by the picking robots 108 and sorted into distinct piles on stacking stations 118. After the singulation process, a product delivery, or pick-bin delivery, phase begins. During the pick-bin delivery phase, the MTE are picked by the picking robots 108 and stacked into piles of similar type and size on stacking stations 118.

In some aspects, one or more picking robots 108 may be configured as tray stacking robots. The tray stacking robots may be operable using a vision sensor. The vision sensor may be a three-dimensional (3D) vision sensor. Additionally, or alternatively, the vision sensor may be infrared (IR) Vision sensor. The picking robots 108 are configured to track content on the picking table section 120 and equipped with a vacuum tool and/or a riser to handle the content from a conveyor in the picking table section 120. The content may be then placed by the picking robots 108 on an outflow conveyor section 116 for final disposition of the stacked MTE and delivery to other mail facilities.

In aspects, before being sorted and stacked by each picking robot 108 on the stacking station 118, each MTE is scanned by one or more scanning devices operable to determine if a conveyed MTE has one or more labels or unapproved material thereon. The labels or unapproved material includes any mailing label, barcode, QR code, mailing code, or other label that is leftover from a prior use of the MTE and should be removed before reuse to inhibit erroneous delivery or confusion as to a destination of the MTE during reuse.

A label cancellation system is configured to receive the MTE identified to include one or more labels and cover the label. The label cancellation system may include a plurality of inspection cameras configured to determine the location of the one or more unapproved material or labels. The label cancellation system may include a material covering device operable to place a non-transparent cover over each of the one or more unapproved material or labels or to apply ink to the unapproved material or label. The label cancellation system may include a label removal device that physically removes the label. The label cancellation system may include a return conveyor to return the MTE to the picking robot 108 or the singulation and sortation section 114 to be delivered to the picking robots 108.

After the picking robots 108 stack the MTE into stacks of a predetermined size, each MTE stack is moved by a stacking station conveyor from the stacking station 118 to the outflow conveyor section 116. The stacking station conveyor may be a conveyor 106 such as a belt conveyor or a roller conveyor. The outflow conveyor section 116 transports the stacks of MTE toward a palletizing area where each stack is wrapped or boxed and placed onto a pallets for distribution to other

FIG. 2 illustrates the MTE separation section 112 in further detail, as described above. The MTE separation section 112 includes a plurality of conveyors 106 arranged successively at alternating angles ∠ (e.g., θ-1, θ-2, θ-3, θ-4) relative to ground. The MTE separation section 112 may thus resemble alpine peaks, with differently angled conveyors configured to separate the MTE as it passes from one conveyor 106 to the next conveyor 106. As the pile of MTE passes from each conveyor 106 to the next, it separates as it falls. The MTE passes from one conveyor 106 to the next at slightly different times (e.g., 1 millisecond or 1 second difference, depending on the size and content of the MTE pile on the conveyor). Each successive conveyor 106 operates at a different speed so that as the MTE falls and touches the next conveyor 106 it is pushed along faster than the MTE falling just behind it to separate the MTE. Because the MTE may be of different sizes, weights, and materials, each MTE may fall at a different rate or touch the next conveyor 106 at a different point along the next conveyor 106.

The receiving conveyor section 110 may be angled at a different angle from at least one of the conveyors 106 of the MTE separation section 112. In aspects, each angle of the conveyors 106 of the MTE separation section 112 and/or of the receiving conveyor section 110 are at a different angle from each other.

In aspects, at least one of the conveyors 106 are arranged at a negative angle or at a decline relative to ground. For example, as illustrated in FIG. 2, the last conveyor 106 before the singulation and sortation section 114 defines an angle θ-4 that is at a negative angle relative to ground. In aspects, two or more of the conveyors 106 are angled at negative angles relative to ground. The negative angles may each be less in magnitude than at least one positive angle of one of the remainder conveyors 106 of the plurality of conveyors 106 of the MTE separation section 112. In aspects, the MTE separation section 112 includes two or more positively angled conveyors 106 and two or more negatively angled conveyors 106. A magnitude of at least one of the positively angled conveyors is greater than a magnitude of each of the two or more negatively angled conveyors 106. One or more negative angled conveyor 106 may be disposed after each positively angled conveyor 106 or may be disposed between positively angled conveyors 106. In aspects, “relative to ground” means relative to horizontal parallel to ground, measured at a starting point of a conveyor.

For example, a first conveyor 106 may define an angle θ-1 of +25 degrees relative to ground, a second conveyor 106 may define an angle θ-2 of +35 degrees relative to ground, a third conveyor 106 may define an angle θ-3 of +30 degrees relative to ground, while a fourth conveyor 106 may define an angle θ-4 of −15 degrees relative to ground. In another example, a first conveyor 106 may define an angle θ-1 of +25 degrees relative to ground, a second conveyor 106 may define an angle θ-2 of +45 degrees relative to ground, a third conveyor 106 may define an angle θ-3 of −30 degrees relative to ground, while a fourth conveyor 106 may define an angle θ-4 of −10 degrees relative to ground. The positive angle of any given conveyor 106 may be from 0 degrees to about 60 degrees, or from 0 degrees to about 90 degrees. The negative angle of any given conveyor 106 may be from 0 degrees to about −60 degrees, or from 0 degrees to about −90 degrees.

In aspects, at least one conveyor is arranged as a declining conveyor in which MTE is moved from to a lower point relative to ground from a higher point relative to ground. In such aspects, an inclining conveyor moves MTE from a lower point relative to ground to a higher point relative to ground. For example, a first conveyor may be arranged horizontally and operable to receive the MTE deposited from a dumper. A second conveyor may be arranged as an inclining conveyor, a third conveyor as a declining conveyor, a fourth conveyor as an inclining conveyor, and a fifth conveyor as a declining conveyor. Conveyors may be arranged in any suitable desired inclining-declining order, and at various angles as described above.

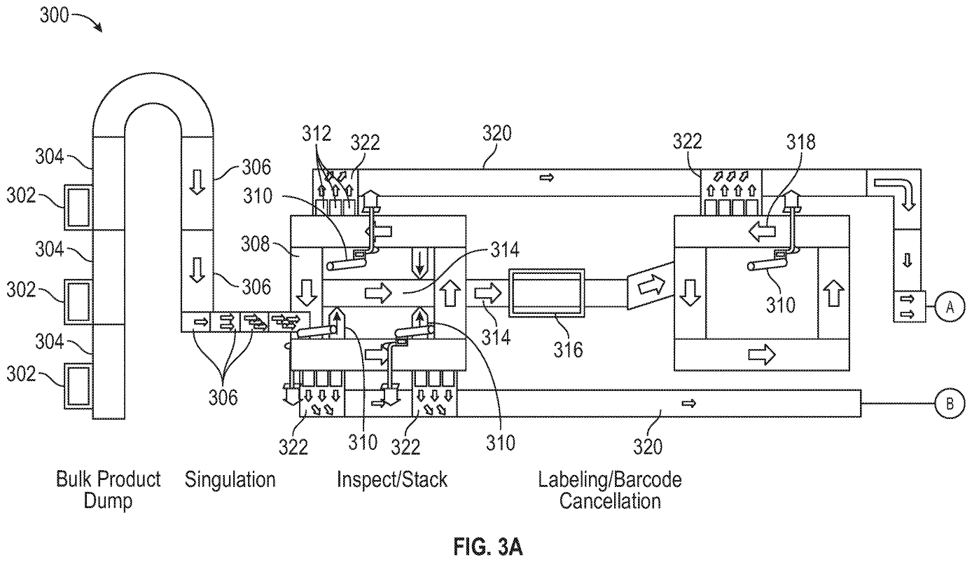

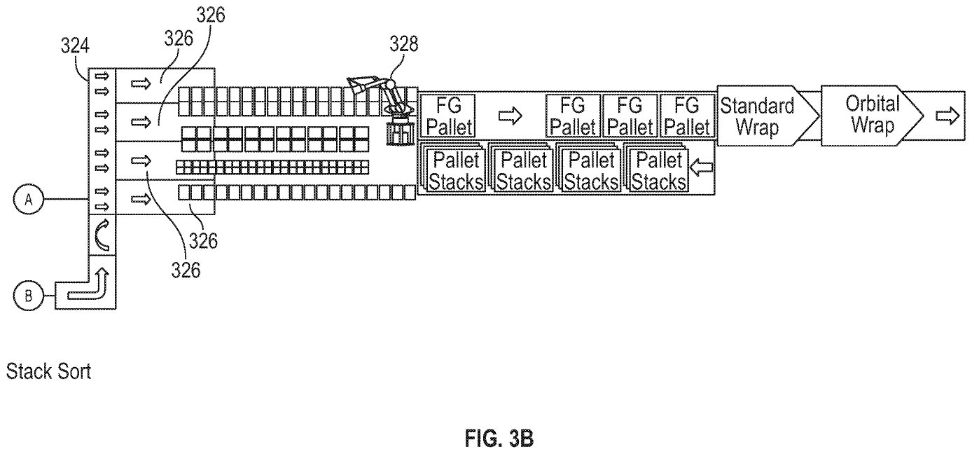

FIGS. 3A-3B illustrates another example automated MTE separation system 300 in accordance with some aspects of the present disclosure. The automated MTE separation system 300 describes an end-to-end robotics and automation system designed to process, for example, mail transport equipment sleeves, parcels, lids, or other similar MTE. The automated MTE separation system 300 processes the mail transport equipment sleeves and lids during various phases of processing like the in the automated conveyor system 100. Various phases of the processing include product dump, singulation, pick-bin delivery, inspection, label cancellation, stack, packet sort, stack transport, stack que, palletization, rope/wrap, and finished pallet take-away, as described in detail below.

The automated MTE separation system 300 includes at least one dumper 302, at least one receiving parcel belt conveyor, a plurality of additional parcel belt conveyors 306, a first conveyor recirculation loop, at least one picking robot 310, at least one tray for receiving picked MTE from the picking robot 310, a label cancellation system 316, and an outflow conveyor 320. The various functions details of each of the components of the automated MTE separation system 300 are described as follows with respect to various phases of the automated MTE separation system 300.

### Bulk MTE Dump Phase:

In a first phase, MTE is dumped from one or more dumpers 302 onto a receiving parcel belt conveyor 304. In FIG. 3A, a plurality of bulk sleeve dumpers 302 are shown. However, there may be more than 3 or less than three bulk sleeve dumpers 302 depending upon the volume of the MTE to be processed in a mail transport equipment sleeves and containers (“MTESC”) processing facilities. The majority of MTE come into the MTESC processing facilities in at least two different forms of containers, for example, gaylord (also known as cardboard) boxes and rolling stock containers. During the first phase of the process, a product dump phase, gaylord boxes and/or rolling stock containers are loaded into the dumper 302 or other lift operable to dispose MTE onto a first conveyor section, a receiving parcel belt conveyor 304. The receiving parcel belt conveyor 304 may be a plurality of separate conveyors or one longer conveyor on which each dumper 302 disposed MTE on.

In aspects, other types of product dumping including fork lift dumpers, opening containers onto the belt or initial bin, dropping the MTE from above, dispensing from another conveyor, or other process to place the MTE in the automated MTE separation system 300. In some examples, the lift may be advance lifts and have a lift capacity of up to 4000 pounds. The lift or dumpers 302 may be able to dump at a height of 60″ and a maximum angle of 125°. The lift or dumpers 302 may be operated using push button controls. The dumpers 302 may have a dimension of 48″×40″×60″ (L×W×H), however, the dumper may have any other suitable dimensions depending on the gaylord boxes or rolling cart containers used in a given MTESC processing facility. The bulk sleeve dumpers may have a carriage height of 77 inches (in.) and have an arc height and length of 149 in. and 96 in., respectively.

### MTE Singulation Phase:

A second phase of the automated MTE separation system 300 is a product singulation phase, wherein the MTE is separated via a plurality of additional parcel belt conveyor 306 of the automated MTE separation system 300. The plurality of additional parcel belt conveyors 306 are arranged in a series of inclining and declining conveyors, similar to the MTE separation section 112 illustrated in FIGS. 1 and 2. Each additional parcel belt conveyor 306 is operated at a higher speed than the previous section. As described earlier with respect to the automated conveyor system 100, separation of the MTE until a predetermined maximum allowable overlap is achieved via the different angles and speeds of the additional parcel belt conveyors 306. In aspects, the maximum allowable overlap of individual MTE may be 5%, 10%, 15%, 20%, or at or below 50%. In aspects, the maximum allowable overlap may be 0%. In aspects, a human operator or a robotic operator may singulate the MTE at a final additional parcel belt conveyor 306 so there is no overlap or a maximum allowable overlap of MTE is met.

In aspects, one or more of the additional parcel belt conveyors 306 may be spaced apart from the remaining additional parcel belt conveyors 306 such that mail, strings, ribbons, plastic wrap, leaves, garbage, and other refuse are separated from the sleeve product prior to entry into the next phase of conveyance.

By way of an example, each of the additional parcel belt conveyor 306 may be about 60 in. wide. In aspects, the additional parcel belt conveyors may define different widths or may narrow the width along its length in the direction of travel of the belt or rollers of each conveyor. In aspects, each additional parcel belt conveyors 306 may have guard rails to protect the MTE from falling from the conveyors. In aspects, the guard rails may define a height of about 24 in. Each additional parcel belt conveyors 306 may be of similar length or may be of differing lengths. For example, each additional parcel belt conveyor 306 may be 16 feet long. In other examples, one or more additional parcel belt conveyors 306 may be 12 feet long, while one or more additional parcel belt conveyors 306 may be 8 feet long.

### Inspection and Stacking Phase:

After the MTE singulation phase, the MTE exits the additional parcel belt conveyors 306 and enters a first conveyor recirculation loop 308 or ‘racetrack’ conveyor configuration, where the MTE is circulated in a 360° loop for inspection and/or stacking. To inhibit the first conveyor recirculation loop 308 from overcrowding with MTE, light curtains may be used to trigger product release from the additional parcel belt conveyors 306 in order to maintain a desired amount of MTE volume on the first conveyor recirculation loop 308. One or more picking robot 310 are positioned inside the first conveyor recirculation loop 308 to pick and stack the MTE into respective stacks on trays 312.

In aspects, the first conveyor recirculation loop 308 may include a plurality of conveyors (e.g, roller or belt conveyors) or a single looped belt or roller conveyor system. In aspects, the first conveyor recirculation loop 308 may be driven by one or more motors, such as one or more electric motors, optionally including a gear-reduction assembly. The one or more conveyor(s) defining the first conveyor recirculation loop 308 may be define a width sufficient to receive any size MTE or MTE of a maximum size. In aspects, the width may be 36 in. The first conveyor recirculation loop 308 may be designed for any other suitable overall width. The one or more conveyors of the first conveyor recirculation loop 308 may be made of a rough top self-extinguishing belt with a guide strip. To keep the MTE moving through the recirculation loop, guard rails may be provided on the conveyors to inhibit the MTE from erroneously falling off the first conveyor recirculation loop 308.

The one or more picking robots 310 are operable to identify an MTE on the first conveyor recirculation loop 308, pick the identified MTE from the first conveyor recirculation loop 308 and stack the identified MTE into a respective pile of MTE. For example, the picking robots 310 may be configured to identify MTE of different sizes and/or materials, and stack respectively sized or type of MTE into respective stacks on trays 312. Each picking robot 310 may include a vision sensor for inspection and identification of each MTE. The vision sensor may be a three-dimensional (3D) vision sensor. Additionally, or alternatively, the vision sensor may be an infrared (IR) vision sensor. The picking robots 108 are configured to track the MTE on the first conveyor recirculation loop 308 and using a vacuum tool, gripper, and/or a riser, to pick up and the MTE and stack the MTE into piles on the trays 312.

One or more scanning devices are disposed to scan a top and a bottom of each MTE as it circulates through the first conveyor recirculation loop 308 to detect any unapproved material on the MTE for covering. In aspects, the picker robots may include one or more scanners or cameras for detecting the unapproved material.

### Label Cancellation Phase

The automated MTE separation system 300 includes a label cancellation phase whereby MTE identified to include any unapproved material is sifted and placed onto a label cancellation conveyor 314. The label cancellation conveyor 314 is configured to receive a labeled MTE determined to have the one or more unapproved material thereon by the scanning device from one of the picking robot 310 and pass the labeled MTE to a label cancellation system 316 configured cover the unapproved material. The label cancellation system 316 includes one or more inspection cameras to determine the location of the one or more unapproved material on the MTE. In aspects, the label cancellation system 316 includes a top inspection camera and a bottom inspection camera. The top inspection camera is operable to view a top of the MTE to determine a presence of unapproved material on a first side of the MTE. The bottom inspection camera is arranged to view an opposite side of the MTE compared to the top inspection camera. the bottom inspection camera operable to determine the presence of unapproved material on the opposite side of the MTE.

Because the MTE may generally be in a flattened state as it circulates through the automated MTE separation system 300, two cameras are sufficient to detect the presence of unapproved material on the MTE. In aspects, a single camera may be used to inspect both sides of the MTE, and either the camera or the MTE are moved enable inspection of both sides of the MTE. In aspects, a third camera may be used to inspect the MTE at an oblique angle relative to the first or second cameras to catch any unapproved material that may not be visible to the top or bottom cameras.

The label cancellation system 316 includes a material covering device operable to place a non-transparent cover over each identified unapproved material or otherwise ink over or render unusable the unapproved material. In aspects, a plurality of material covering devices are provided, wherein a first material covering device may apply a cover to unapproved material on a first side of the MTE and a second material covering device may apply a cover to unapproved material on an opposite side of the MTE. The label cancellation system 316 then moves the now “label canceled” MTE to a second conveyor recirculation loop 318 where one or more picking robots 310 are stationed to pick and stack the MTE in the same manner as in the first conveyor recirculation loop 308. The material covering device(s) are configured to apply an ink covering to blot out the existing ink or to apply a blank label that covers over the unapproved material. Examples of unapproved material include barcodes, QR codes, 2D codes, and or 3-D codes.

### Stack and Palletize Phase

The automated MTE separation system 300 includes a stack and palletize phase where stacks of MTE are moved from the stacking stations 118 to one or more outflow conveyors 320 via tray conveyors 322 that move trays with stacked MTE onto a respective outflow conveyor 320. The outflow conveyor 320 is coupled to a stack sortation conveyor 324. (See FIG. 3B) The stack sortation conveyor 324 may be a bidirectional conveyor or dual activated roller bed (“DARB”). The dual activated roller bed is configured to move stacks in different directions to sort the trays of stacked MTE into respective accumulation conveyors 326. The stack sortation conveyor 324 has, for example, an overall conveyor length of 20 feet and an overall length at frames of, for example, 20 feet with a belt width of 20 inches. The stack sortation conveyor 324 may have a plurality of diverters, for example, four right diverters to divert stacks of MTE onto respective accumulation conveyors 326.

In aspects, there may be as many accumulation conveyors as types of MTE processed. For example, there may be three accumulation conveyors 326, each for respectively receiving and conveying one of three sizes or types of MTE. In other examples, there may be four accumulation conveyors 326, each respectively receiving and conveying one of four types of MTE. One or more palletizing robot palletizing robots 328 are operable to stack accumulated stacks of MTE on the accumulation conveyors 326 onto pallets, which are then moved and wrapped using a standard stretch-wrapping machine and/or an orbital stretch-wrapping machine for transfer to other mail processing facilities for reuse.

In aspects, the tray conveyors 322 may have a plurality of zones for various trays for receiving different types of MTE using retro-reflective type EZ logic zone controllers. In order to keep MTE on the tray conveyors 322 in stacks, guard rails may be provided between each tray 312. The guard rails may be tiering adjustable universal channel guard rails.

In aspects, the automated MTE separation system 300 may include the label cancellation system 316 within the first conveyor recirculation loop 308 such that the second conveyor recirculation loop 318 is not needed or may instead be provided to handle additional MTE to increase MTE processing volume.

In aspects, the automated conveyor systems and automated MTE separation systems of this disclosure may be defined by a plurality of subsystems including a bulk product subsystem, an infeed subsystem, an outfeed subsystem, and a palletizing subsystem. The bulk product subsystem may also be referenced herein as a product entry point subsystem.

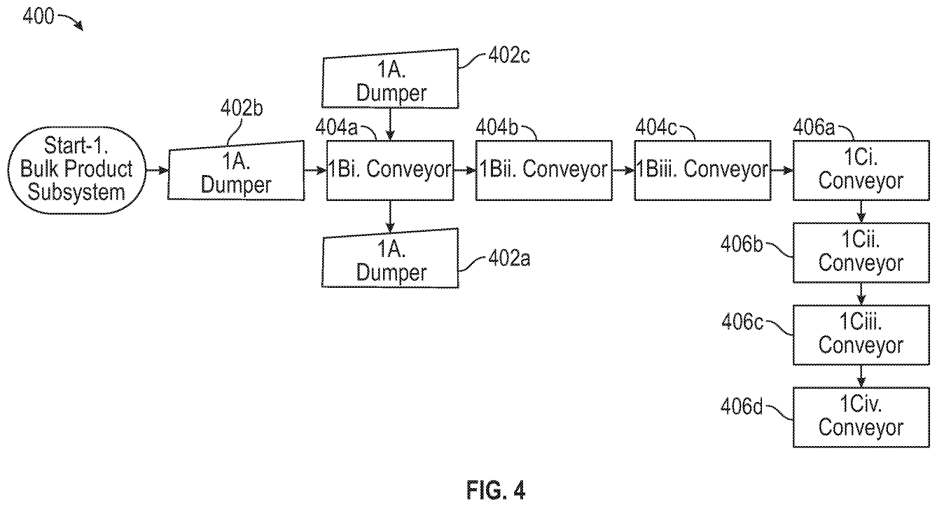

With reference to FIG. 4, a product entry point subsystem separates bulk containers of MTE (sleeves, carriers, or other similar MTE) being dumped onto conveyors via tote dumpers using a plurality of conveyors in an alpine configuration. In the alpine configuration, as discussed above, the conveyors utilize a “waterfall” or “alpine” design and variable speed adjustments and angles to separate or “singulate” MTE on the conveyors as much as possible before transferring MTE to the infeed subsystem. During this process, foreign objects (e.g., unwanted plastic, banding, trash, etc.) are removed in an automated manner via the waterfall design while MTE is singulated and dropped on to a conveyor (e.g., a slider bed belt conveyor or roller conveyor) positioned at the beginning of the infeed subsystem where the singulated MTE is picked and stacked. Equipment and system design requirements of the bulk product subsystem may vary based on site dimensions and annual product throughput requirements.

The bulk product subsystem 400 includes tote dumper 402a, a first plurality of conveyors 606 (e.g., conveyors 404a, 404b, and 404c), and a second plurality of conveyors 406 (e.g., conveyors 406a, 406b, 406c, and/or 406d). The first plurality of conveyors 606 may define alternating angles, such as negative, positive, and then negative angles, or in any desired order angle order. For example, the angle of conveyor 404a may be −12 degrees, the angle of conveyor 404b may be 21 degrees, and the angle of conveyor 404c may be −15.1 degrees. The second plurality of conveyors may each also define different angles, alternating or in any desired order angle order. For example, the angle of conveyor 406a may be 9.4 degrees; the angle of conveyor 406b may be 27 degrees; the angle of conveyor 406c may be 10 degrees and the angle of conveyor 406d may be −3.2 degrees. Each of the conveyors of the plurality of conveyors 606, 406, may be run at the same or different speeds relative to adjacent conveyors. In aspects, each successive conveyor is operated at a higher speed. The overall length and width of each of the first and second pluralities of conveyors 606, 406 may be designed to fit within a particular MTESC processing facility and/or various MTE sizes and total volume.

Tote dumper 402a may have a lifting capacity of 4000 pounds, and a carriage of 60 in.×60 in. and a height of 96 in to accommodate standard gaylord and/or rolling cart containers. The tote dumper 402a are configured to accommodate gaylords of any size such as, 99BS (small Gaylord, 42″×48″×37″), 99BL (large Gaylord, 42″×48″×62″), 82 (XL Gaylord, 42″×48″×70″).

The first and/or second sets of conveyors are configured to transport deep piles of MTE (e.g., 48 in. or 60 in. deep piles), and singulate product to a depth of 2″ or less, and/or at a low jam rate (e.g., less than 5% or 0%). Additionally, or alternatively, the first and/or second pluralities of conveyors 606, 406, are configured to create slugs of MTE that can divert from transfer conveyors (for example, having a maximum slug width of 40″ and a maximum slug height of 7″) and able to remove almost 100% of non-sleeve products. A slug of MTE means a pile of MTE no higher than a maximum height (e.g., two inches, three inches, or five inches) with a maximum acceptable overlap of MTE (e.g., less than 50% overlap, less than 30% overlap, or less than 15% overlap).

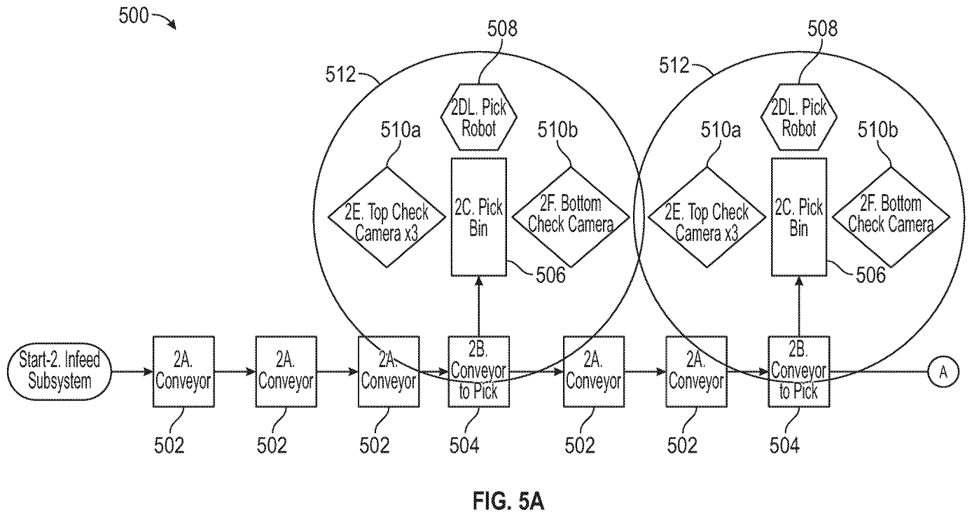

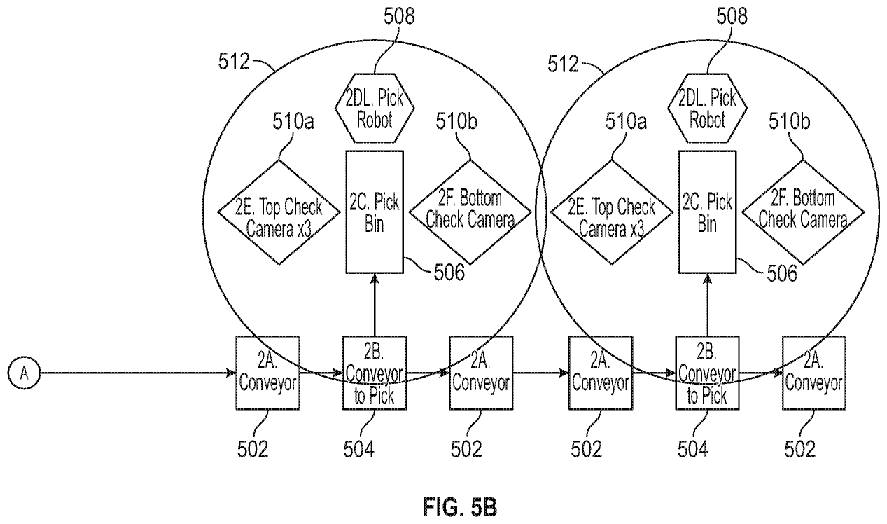

With reference to FIGS. 5A-5B, an infeed subsystem 500 includes a plurality of slider bed belt conveyors 502, a plurality of zero pressure accumulation conveyors 504, a plurality of pick bins 506, and a plurality of picking robots 508, a plurality of top check camera 510a, and a plurality of bottom check camera 510b.

The plurality of slider bed belt conveyors 502 convey slugs of MTE to the accumulation conveyors 504 which divert MTE into the plurality of pick bins 506. The accumulation conveyors 504 may include pop-up diverters to divert a given type or size of MTE as determined by one or more scanning systems as the MTE passes over the accumulation conveyors 504. The scanning devices may be cameras for visual determination or may measure a material type, weight, length, width or depth of a given MTE. This process is repeated in each robot cell 512 shown in FIGS. 5A-5B. In FIGS. 5A-5B, four robot cell 512 are shown; however, any number robot cells robot cell 512 may be provided in the infeed subsystem 500. As a result, any product that is missed in a robot cell 512 may be processed in a subsequent robot cell upon entry into the subsequent robot cell 512.

The infeed subsystem 500 identifies a label on each sleeve via the top check camera 510a and/or the bottom check camera 510b. The label may be a machine-readable image such as, a barcode, a Quick Reference (QR) code, etc. The top check camera 510a and/or the bottom check camera 510b may be a 12 megapixels (MP) camera with a red torch-high resolution light camera or other high definition camera or imaging device for detecting label codes (e.g., barcodes, QR codes, 2D codes, 3D codes, text labels, or other label mechanisms).

Each MTE is scanned by the top and bottom check cameras 510a, 510b, and if a label is present, the MTE will be directed to a labeling robot cell wherein the label is covered using a label covering machine. If no label is present, the sleeve may be separated by product-specific type and may be placed on a corresponding stack building conveyor of an outfeed subsystem 600.

Additionally, or alternatively, dedicated overhead top check camera 510a may verify if a label is present on the top of each stacked sleeves. If a label is detected, a picking robot 508 may re-grip the sleeve and place the sleeve into the labeling robot cell or a conveyor that convey's the labeled MTE to a label cancellation system. Once a label is applied, the MTE may be redirected through the infeed subsystem 500. If no label is detected, the MTE may remain in the stack for moving to the outfeed subsystem for palletization.

Each of the plurality of slider bed belt conveyors 502 may have, for example, an overall width of 36″ and variable length, as needed. Further, each of the plurality of slider bed belt conveyors 502 may have 9″ high solid side guards to protect the content on the plurality of slider bed belt conveyors 502. Further, the plurality of slider bed belt conveyors 502 may be operated such that products are consistently delivered to a pick bin of the plurality of pick bins 506 to accommodate an 18 piece per minute throughput rate.

The plurality of accumulation conveyors 504 are configured as modular timing belt transfers. The accumulation conveyors 504 may define a 34 inch overall width and an overall length of about 3 ft to about 6 ft. The plurality of accumulation conveyors 504 is able to deliver products to a pick bin of the plurality of pick bins 506, at a predetermined rate. The predetermined rate may be an 18 unit per minute throughput rate, or a 25 unit per minute throughout rate.

Each pick bin of the plurality of pick bins 506 may be a steel bin (e.g., made of 16-gauge steel). Each pick bin 506 may be configured to receive a predetermined amount of MTE that can be sifted by the picking robots 508. The pick bins 506 may define dimensions of 36 in.×60 in.×10 in. (L×W×H or WxLxH). Further, each pick bin 506 may a support frame of ½″ square steel tube support, which may be, for example, 18″ tall with mounting pads. 16-gauge steel chute may be formed in sides with a dimension of 16″×60″, which may have insider corners to have radius bends. Each pick bin may be configured to receive one or more MTE product types from “conveyor to pick” conveyance in a manner that allows the picking robots 508 to effectively pick and place the MTE to accommodate an 18 piece per minute throughput rate.

A pick robot 508 of a plurality of pick robots labeled as 508 may include a gripper (or any other tool attached at an end of the robot arm), a robot riser, a wire mesh safety fencing, and/or a plurality of safety devices (e.g., locking door switches, push to escape, E-stop, etc.) Additionally, or alternatively, the picking robot 508 may also have a control panel, camera stands and may be configured to consistently pick up and place/release a product to accommodate an 18 piece per minute throughput rate. Further, the picking robot 508 may also have a cable management package for controlling movement of the picking robot 508.

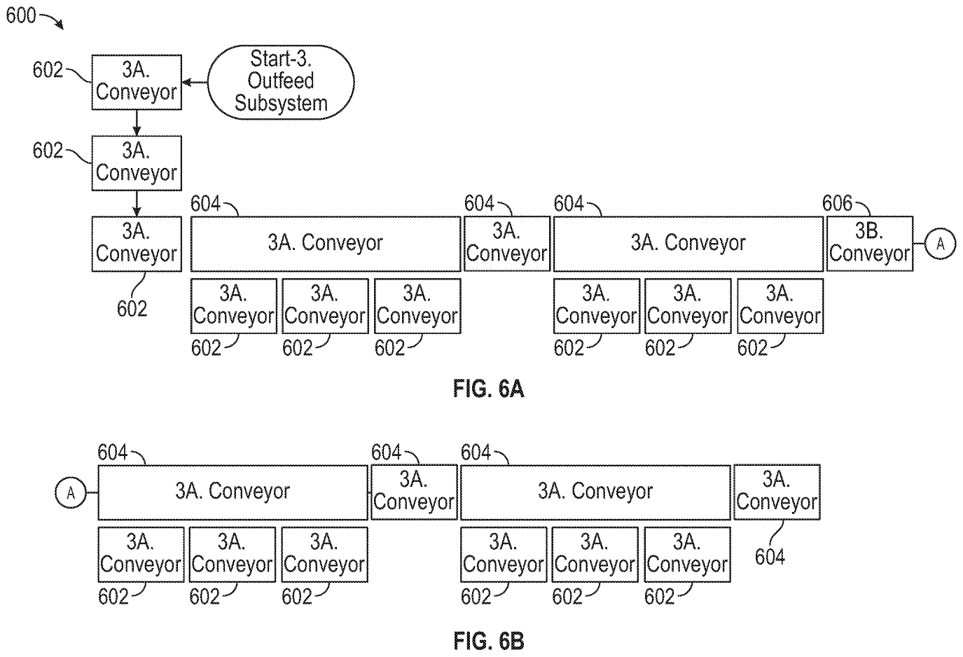

FIGS. 6A-6B illustrate an example outfeed subsystem 600 that includes a plurality of zero pressure accumulation conveyors 602, a plurality of stack outflow conveyors stack outflow conveyor 604 and a powered gate conveyor 606. The picking robots 508 in each robot cell 512 are configured to pick and place MTE into respective accumulation conveyors 602 for each type of MTE until that type of MTE reaches a predetermined size or amount. For example, “EM sleeves,” one example type of MTE, may be stacked into approximately 45 sleeves per stack. In another example, “EMM sleeves” another example type of MTE, may be stacked into approximately 43 sleeves per stack. In another example, “half MM sleeves,” another example type of MTE may be stacked into approximately 42 sleeves per stack. Each stack may be of any predetermined size based on the type of MTE. For example, some MTE may be stacked with 15 MTE units per stack while others may be stacked with 60 MTE units per stack.

The picking robots 508 may identify a given MTE type using one or both of the top check camera 510a and bottom check camera 510b. The picking robot then places the identified MTE onto the respective accumulation conveyor 602 assigned for that MTE. The picking robot 508 would identify each sleeve for pick up using 3D vision technology based upon image data from camera sensors of the pick robot, or the top check camera 510a or the bottom check camera 510b.

Each accumulation conveyor 602 may have a variable length and an overall width of about 2 feet, (e.g., 22 inches or 28 inches). Each accumulation conveyor 602 may be configured for variable modular timing belt transfers.

When a stack of MTE reaches its maximum size, the accumulation conveyors 602 pass the accumulated stack of MTE onto the stack outflow conveyor 604, which then delivers the stack to a palletizing system that sorts the similar stacks of MTE onto pallets.

The powered gate conveyor 606 is provided to enable access to an operator to fix, repair, or otherwise maintain the outfeed subsystem 600 by raising and lowering a section of conveyor defined by the powered gate conveyor 606. The powered gate conveyor 606 may have an overall width of 28 inches and an overall length of 5 feet.

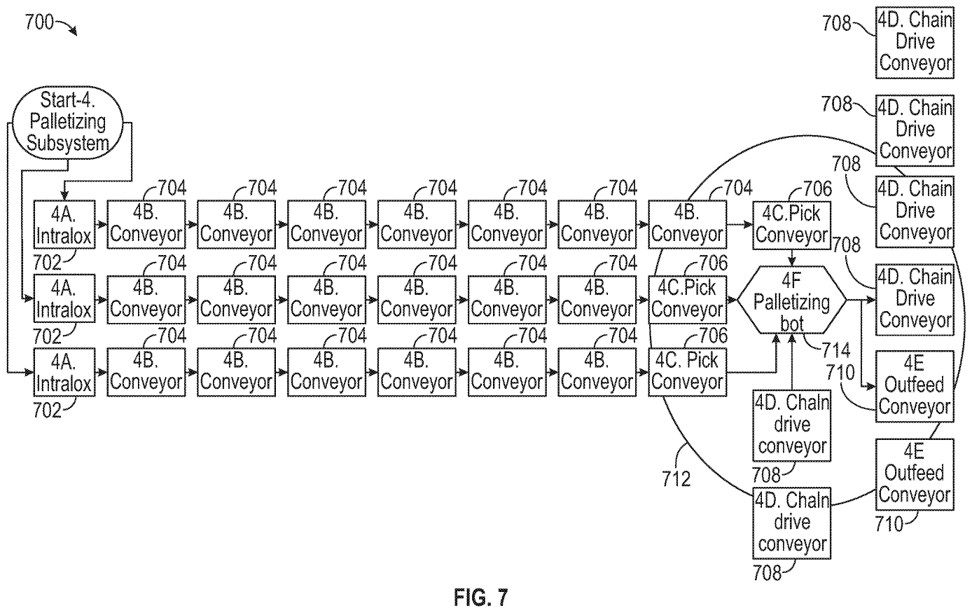

FIG. 7 illustrates an example palletization subsystem 700 including a plurality of roller bed sorters 702, a plurality of stack conveyor 704, a plurality of pick conveyor 706, a plurality of chain driven live roller conveyor 708, one or more outfeed conveyor 710, and one or more robotic palletizing cells 712.

The roller bed sorters 702 move given stacks of MTE to a particular plurality of stack conveyor 704. The stack conveyor 704 advance the MTE stacks to a pick conveyor 7 where a palletizing robot 714 places similar stacks of MTE onto a pallet until the pallet reaches a maximum allowable amount of stacks. The chain driven live roller conveyor 708 moves the completed pallets away for further processing and delivery to other mail facilities.

The robotic palletizing cell 712 may be configured to operate one product (or one stock keeping unit (SKU)) at a time. The palletizing robot 714 may pick up a pallet from an infeed stack (not shown in FIG. 7) and place it in a build zone. In aspects, if the palletizing robot detects multiple nested pallets, for example, after placing the pallets in the build zone, the palletizing robot may re-grip or pick up and place any extra pallets on an outfeed conveyor of the outfeed conveyor 710.

The palletizing process continues until there are no more products that require handling.

The plurality of roller bed sorters (such as, dual activated roller bed roller bed sorters 702 may have a belt width of 22″ and an overall length of 20′, for example. The plurality of stack conveyor 704 may have an overall width of 30″ while having a variable overall length and/or a variable zone length. The pick conveyors 706 may have an overall width of 30″ and an overall length of 4′. The plurality of chain driven live roller conveyors 708 may have a variable overall length and an overall width of 55″.

The one or more robotic palletizing cell 712 may have a robot riser, a wire mesh safety fencing, a plurality of safety features (e.g., locking door switch, push to escape buttons, e-stops, and muting light curtains, etc.), an end of arm tool, an electrical panel, etc.

The mail transport service center according to the plurality of subsystems shown using FIG. 4 to FIG. 7 may have a pallet output, for example, as shown in the Table below.

| | | | | | | Stacks* | Items | | | |
|---|---|---|---|---|---|---|---|---|---|---|
| Sleeve | | | | Stack | | per | per | | | |
| type | ID | Pallets/Hr | Stacks/Hr | pattern | Lbs. | pallet | pallet | W″ | D″ | H″ |
| EM | 75 | 4.5 | 68 | Five stack | 656 | 15 | 666 | 41 | 50 | 50 |
| EMM | 75E | 2.2 | 27 | Four stack | 565 | 12 | 519 | 40 | 48 | 50 |
| Half | 75H | 1.4 | 37 | Nine stack | 589 | 27 | 1131 | 40.5 | 49 | 50 |
| MM | | | | | | | | | | |

In the table, pallets are 40″×48″ or nine block postal pallets. Various specifications, dimensions, and/or capacity mentioned in the present disclosure are for example only, and do not limit any other specifications, dimensions, and/or capacity.

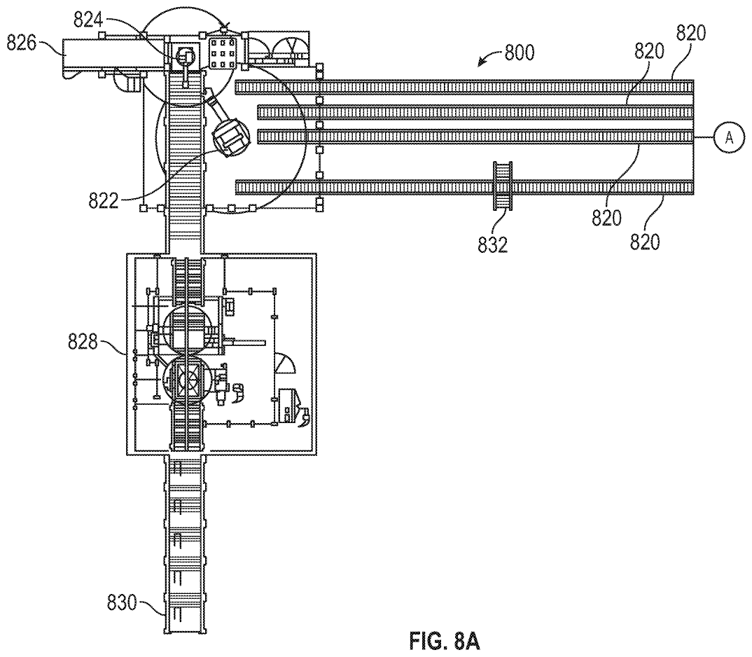

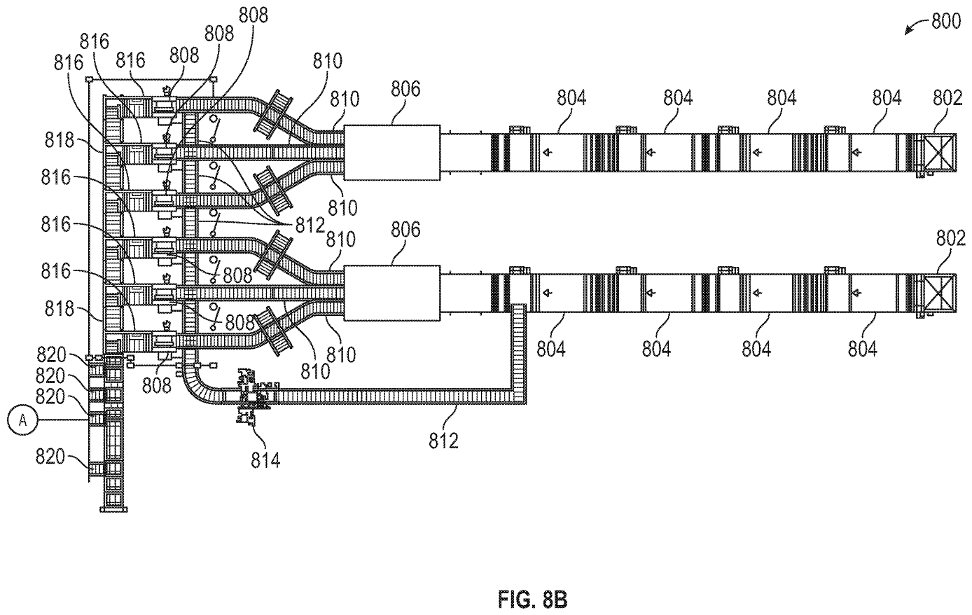

FIGS. 8A-8B illustrate an automated MTE separation system 800 for separating MTE, including sleeves, mailers, parcels, etc. The automated MTE separation system 800 may be configured to separate a single type of MTE or two or more types of MTE, and may further be configured to separate different sizes of the types of MTE, similar to automated conveyor system 100 or automated MTE separation system 300.

The automated MTE separation system 800 includes one or more dumpers 802 operable to deposit MTE from a gaylord, rolling cart containers, or other bulk container onto a respective receiving parcel belt conveyor 804. The automated MTE separation system 800 may include one or more pluralities of additional parcel belt conveyors arranged in series.

In aspects, the automated MTE separation system 800 is illustrated as two paths of the pluralities of parcel belt conveyors 804 each with a respective dumper. The paths may be in parallel or may be arranged to fit within a particular MTESC processing facility or other warehouse facility. The automated MTE separation system 800 may include three paths defined by three different pluralities of parcel belt conveyors 804 and respective dumpers 802.

Each of the additional parcel belt conveyors 804 are angled relative to one another at predetermined angles to singulate the MTE deposited on the parcel belt conveyors 804, as described earlier with respect to FIGS. 1 and 2. Each parcel belt conveyor 804 of a plurality of parcel belt conveyors are each angled relative to ground at a different angle from each other. Each parcel belt conveyor 804 may be operated at a different speed, including a higher speed than a prior parcel belt conveyor 804, to operably separate MTE deposited thereon. The pluralities of parcel belt conveyors may have matching angled parcel belt conveyors 804 relative to the parcel belt conveyors 804 of the other plurality of parcel belt conveyors. In other words, the first plurality of parcel belt conveyors need not be differently angled than the second plurality of parcel belt conveyors 804. In aspects, each plurality of parcel belt conveyors defines different angled parcel belt conveyors 804 for processing different sizes or types of MTE as may be determined to achieve separation and singulation of different MTE. The parcel belt conveyors 804 are thus operable to deshingle or singulate a pile of MTE deposited thereon.

In aspects, parcel belt conveyors 804 are spaced from each other such that refuse or non-MTE products are separated from the MTE. Removal of refuse and non-MTE product may be achieved as a result of the weight of the refuse or non-MTE products being lighter than the MTE and not traveling as far as the MTE when falling from one parcel belt conveyor 804 to the next parcel belt conveyor 804. Each parcel belt conveyor 804 may thus be operated at a speed and/or arranged at an angle that moves the MTE to the next parcel belt conveyor 804 while the refuse is not able to be moved to the next parcel belt conveyor given the operating speed and arranged angle.

The plurality of parcel belt conveyors 804 singulate and deliver the MTE to a respective multi-directional or omnidirectional sortation conveyor 806. The plurality of parcel belt conveyors 804 may be arranged in an alpine or waterfall configuration achieve a predetermined maximum overlap of MTE, e.g., maximum of 5% overlap, a maximum of 15%, 20% overlap, 50% overlap, 90% overlap or no overlap, etc., depending on the MTE to be sorted and an acceptable error rate. The maximum allowable overlap may leave as little as 10% of any individual MTE exposed to enable a picking robot 808 to grasp or pick the individual MTE. The plurality of parcel belt conveyors 804 are thus operable to generate a singulated line of MTE that is moved to the sortation conveyor 806.

The sortation conveyor 806 includes a plurality of rollers independently operable to move MTE in different directions to sort the MTE into respective sorting line conveyors 810 for each type of MTE. The plurality of independently operable rollers is configured to further singulate the MTE received and direct each MTE to a respective one of the plurality of sorting line conveyors 810. One or more sensors may be provided for identification of the type of each MTE to instruct the sortation conveyor 806 to move an identified MTE to an appropriate sorting line conveyor 810. The sortation conveyor 806 is thereby operable to sort MTE into a respective plurality of sorting line conveyors 810. The sensor may be a camera system operable to identify each MTE type based on a picture of the MTE. The sensor may be a weight sensor, light sensor, or other sensor operable to detect one or more parameters associated with a type of MTE unique to that type of MTE to enable the sortation conveyor 806 to sort the MTE to respective sorting line conveyors 810.

The sortation conveyor 806 is operable to sort MTE that is singulated to the maximum allowable overlap. In aspects, the sortation conveyor 806 is operable to further singulate the MTE, for example from a maximum of 10% overlap to a maximum of 5% overlap, or no overlap.

As illustrated in FIGS. 8A-8B, the automated MTE separation system 800 includes three sorting line conveyors 810 per sortation conveyor 806. However, more or less sorting line conveyors 810 may be provided depending on the number of types of MTE to be sorted.

The plurality of sorting line conveyors 810 move the sorted MTE toward a plurality of respective picking robots 808 that stack the sorted MTE onto a plurality of respective stacking station conveyors 816 for each respective sorting line conveyor 810, as illustrated by way of example in FIGS. 8A-8B. In aspects, the plurality of sorting line conveyors may each terminate in a pick bin collecting the particular MTE on the sorting line. In such aspects, the picking robot may pick the MTE from the pick bin.

One or more scanning devices are provided along each sorting line conveyor 810 to determine if a conveyed MTE from the sortation conveyor 806 includes unapproved material, such as an old labels, barcodes, QR codes, addresses, etc. If an MTE is determined to include unapproved material thereon, the MTE is moved to a label cancellation recirculation loop 812. The MTE may be moved automatically using one of the picking robots 808, or using a multidirectional conveyor at an intersection of the sorting line conveyor 810 and the label cancellation recirculation loop 812. In aspects, each of the picking robots 808 include or are coupled to the scanning devices, including cameras or light sensors to detect the presence of unapproved material on a given MTE. In aspects, the scanning devices are operable to scan a top and a bottom of the MTE to detect the present of the unapproved material on either side.

The label cancellation recirculation loop 812 moves the MTE with the unapproved material to a label cancellation system 814. The label cancellation system 814 is configured to receive the labeled MTE and inspect the MTE using a plurality of inspection cameras to determine a location of the one or more unapproved material on the MTE. The label cancellation system then covers the unapproved material with a blank label or otherwise covers or inks over the unapproved material. The now label cancelled MTE is returned to either the parcel belt conveyors 804 or the sortation conveyor 806 for re-processing and sortation to the sorting line conveyors 810.

In aspects, automated MTE separation system 800 includes one label cancellation recirculation loop 812 and one label cancellation system 814 to handle all MTE with unapproved material. In other aspects, each path of parcel belt conveyors 804, sortation conveyor 806, and sorting line conveyors 810 includes a dedicated label cancellation recirculation loop 812 and label cancellation system 814.

The picking robots 808 stack the MTE on the stacking station conveyor 816. When a stack reaches a predetermined height or volume of MTE for a given MTE being stacked, the stacking station conveyors 816 move the stack of MTE onto an outfeed conveyor 818. In aspects, each stack is wrapped, tied, or boxed to keep the stack together, e.g., using wrap, string, straps, or other stack containing devices,

The outfeed conveyor 818 moves the stacks of MTE toward palletizing conveyors 820. There may be a palletizing conveyor 820 for each type of MTE stack. The palletizing conveyors 820 moves the MTE toward a palletizing robot 822 that stacks that stacks of MTE onto pallets on a pallet conveyor line 834.

The automated MTE separation system 800 may include a destacking robot 824 that places pallets from a pallet stack infeed 826 onto the pallet conveyor line 834.

Once a pallet reaches a predetermined limit of stacks of MTE, the pallet is moved to a pallet wrapping system 828 by the pallet conveyor line 834. The pallet wrapping system 828 applies wrap to each pallet to secure the stacks of MTE on the pallet. The wrap may be a standard and/or orbital wrap to wrap all sides of the MTE stack on a given pallet. The pallet wrapping system 828 may include a direction strapper and/or a stretch wrapper.

The wrapped pallets of MTE are then moved to a complete pallet queue 830 for distribution of the pallets of MTE to other mail facilities for reuse.

In aspects, access ladders 832 are provided to enable operators to access various parts of the automated MTE separation system 800.

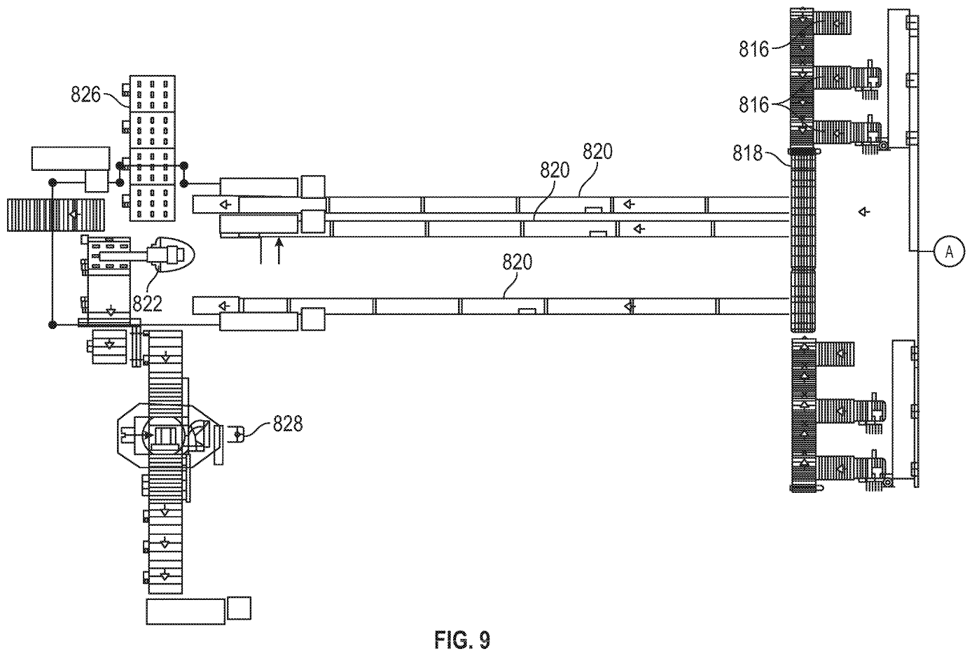

FIG. 9 illustrates an alternate arrangement of the automated MTE separation system 800 in comparison with FIG. 8A, wherein the palletizing conveyors 820 are disposed along a middle section of the outfeed conveyor 818, such that a first path of singulation and stacking of MTE conveys stacks of MTE from a first side of the palletizing conveyors 820 while a second path of singulation and stacking of MTE conveys stacks of MTE from a second side of the palletizing conveyors 820.

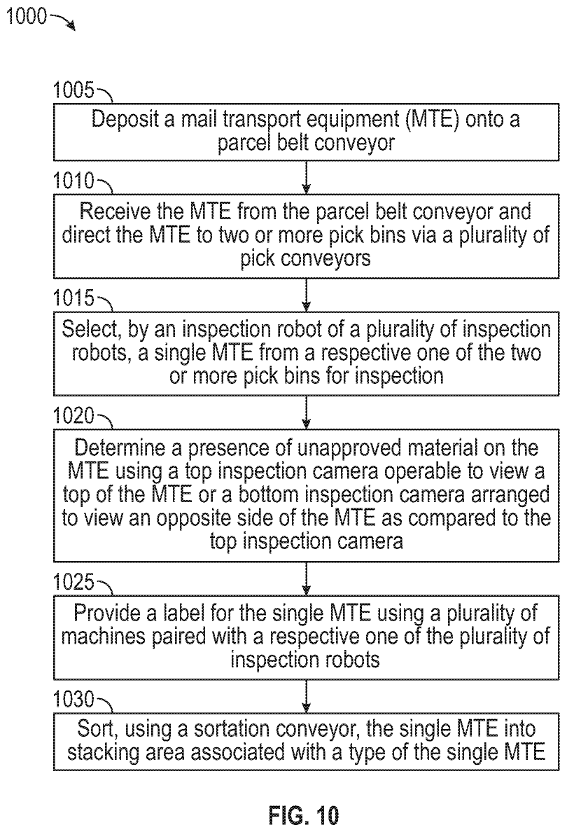

FIG. 10 illustrates a method 1000 for separating mail transport equipment (MTE). The method includes, at step 1005, depositing mail transport equipment (MTE) onto a parcel belt conveyor.

The method includes, at step 1010, receiving the MTE from the parcel belt conveyor and directing the MTE to two or more pick bins via a plurality of pick conveyors. The MTE may be present or stored in a dumper of a plurality of dumpers. The dumper may be operable to receive sleeves contained within a gaylord or the MTE directly. The MTE may include multiple different types of sleeves. The parcel belt conveyor may include a plurality of parcel belt conveyors, and each parcel belt conveyor of the plurality of parcel belt conveyors may be angled at a different angle relative to the ground as compared to another parcel belt conveyor of the plurality of parcel belt conveyors.

In some examples, at least one of the plurality of parcel belt conveyors may be angled at a negative angle. In other examples, two or more of the plurality of parcel belt conveyors may be angled at a negative angle. The two or more negative angle parcel belt conveyors may have an angle that is less in magnitude than at least one of a remainder of the plurality of parcel belt conveyors. Alternatively, or additionally, at least two of a remainder of the plurality of parcel belt conveyors may be angled at a positive angle and a magnitude of at least one of the remainder of the plurality of parcel belt conveyors is greater than a magnitude of each of the two or more negative angle parcel belt conveyors. Further, each of the plurality of parcel belt conveyors may have the same length.

Further, the plurality of pick conveyors may separate the MTE between the two or more pick bins. By way of an example, the pick bins may be four or more pick bins. The plurality of pick conveyors may include at least two slider bed belt conveyors and at least two timing belt transfer conveyors that change the direction, for example, from direction of travel of the at least two slider bed belt conveyors toward a respective one of the two or more pick bins.

The method includes, at step 1015, selecting, by an inspection robot of a plurality of inspection robots, a single MTE from a respective one of the two or more pick bins for inspection. The plurality of inspection robots may be associated with a respective one of the two or more pick bins and operable to lift the MTE from the respective one of the two or more pick bins.

The method includes, at step 1020, determining a presence of unapproved material on the MTE using a top inspection camera operable to view a top of the MTE or a bottom inspection camera arranged to view an opposite side of the MTE as compared to the top inspection camera.

The method includes, at step 1025, providing a label for the single MTE using a plurality of machines paired with a respective one of the plurality of inspection robots. The plurality of inspection robots may also carry a material covering device operable to cover the unapproved material on the MTE. The material covering device applies one of an ink covering or a blank label covering to the MTE.

The method includes, at step 1030, sorting, using a sortation conveyor, the single MTE into stacking area associated with a type of the single MTE. The sortation conveyor may include three or more roller bed sorters that place the MTE onto one of three accumulation conveyors. Additionally, each of the three accumulation conveyors may correspond to one of three types of MTE.

Additionally, three pick conveyors and a palletizing robot may be used to reach each of the three pick conveyors that corresponds with one of the three accumulation conveyors. Further, at least three different receiving conveyors may be provided to receive the MTE from a palletizing robot.

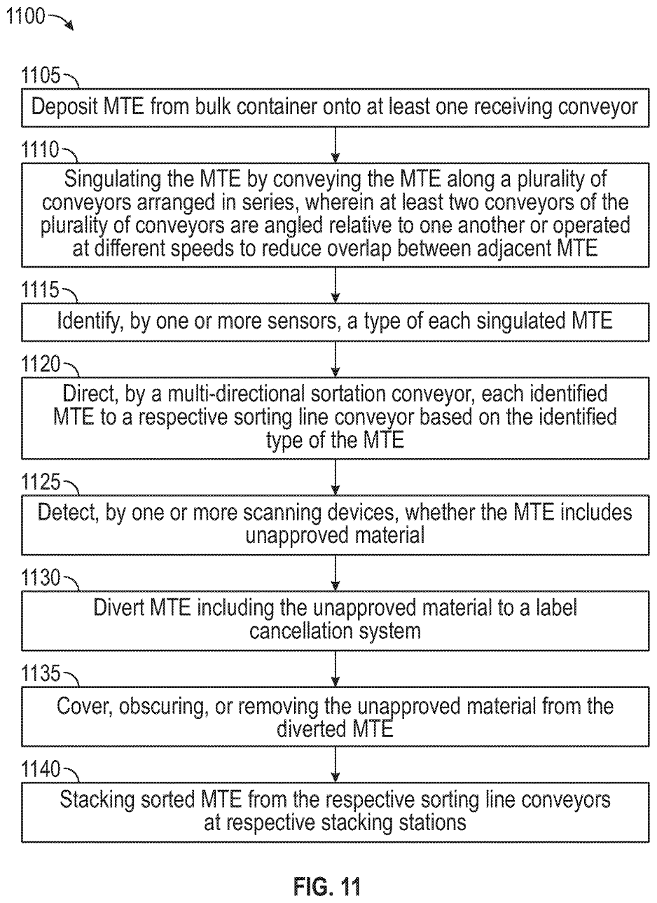

FIG. 11 illustrates a flowchart of a method 1100 for sorting mail transport equipment (MTE), including sleeves, mailers, parcels, trays, containers, or other reusable mail transport equipment. At block 1105, MTE is deposited from a bulk container onto at least one receiving conveyor. The bulk container may include a gaylord, rolling cart container, pallet container, or other container configured to hold unsorted MTE.

At block 1110, the MTE is singulated by conveying the MTE along a plurality of conveyors arranged in series. In aspects, at least two conveyors of the plurality of conveyors are angled relative ground at different angles from one another and/or operated at different speeds, to separate and singulate the MTE and reduce overlap between adjacent MTE. The plurality of conveyors may be arranged successively at alternating positive and negative angles relative to ground so as to define an alpine or waterfall configuration. As a pile of MTE passes from one conveyor to a successive conveyor, individual MTE may fall at different times, fall at different rates, or contact the successive conveyor at different locations based on the size, weight, stiffness, material, or orientation of the individual MTE. The method may include operate successive conveyors at a different speed so that MTE contacting the successive conveyor earlier is advanced away from MTE falling behind it, thereby increasing separation between adjacent MTE. In aspects, one or more conveyors are arranged at a negative angle relative to ground, and a magnitude of the negative angle may be less than a magnitude of at least one positive angle of another conveyor. For example, the plurality of conveyors may include positively angled conveyors of about +25 degrees, about +35 degrees, or about +45 degrees, and one or more negatively angled conveyors of about −10 degrees, about −15 degrees, or about −30 degrees.

At block 1115, a type of each singulated MTE is identified by one or more sensors. The one or more sensors may include a camera, weight sensor, light sensor, barcode reader, image-recognition system, or other sensor configured to detect a parameter associated with the MTE. In aspects, the identified type may include a sleeve, mailer, parcel, tray, container, or size category thereof.

At block 1120, each identified MTE is directed, by a multi-directional sortation conveyor, to a respective sorting line conveyor based on the identified type of the MTE. In aspects, the multi-directional sortation conveyor is operable to move each MTE in a plurality of directions to route different types or sizes of MTE to corresponding sorting line conveyors. The sortation conveyor may also further reduce overlap between adjacent MTE before the MTE is discharged to the respective sorting line conveyors.

At block 1125, one or more scanning devices detect whether the MTE includes unapproved material, including old labels, barcodes, QR codes, addresses, or other markings. In aspects, the one or more scanning devices scan a top side, a bottom side, or both sides of the MTE.

At block 1130, MTE including the unapproved material is diverted to a label cancellation system. The MTE may be diverted by a picking robot, a multi-directional conveyor, or another diverter to a recirculation loop on which the label cancellation system is disposed.

At block 1135, the unapproved material is covered, obscured, removed, or inked over by the label cancellation system. In aspects, the label cancellation system includes one or more inspection cameras configured to determine a location of the unapproved material before the unapproved material is cancelled to ensure accurate placement of the cover over the unapproved material. The MTE may then be returned for re-processing after the unapproved material is cancelled.

At block 1140, sorted MTE from the respective sorting line conveyors is stacked at respective stacking stations. In aspects, the stacked MTE may be moved to an outfeed conveyor, palletized, wrapped, queued, or otherwise prepared for storage, distribution, or reuse.

As used herein, MTE may be described as defining a type of MTE or a size of MTE, though type may also refer to a size of MTE. In aspects, a species of MTE means a specific type and size of MTE. For example, MTE includes three species of sleeves, e.g., large plastic sleeve, medium plastic sleeve, and small plastic sleeve, or large cardboard sleeve, medium cardboard sleeve, small cardboard sleeve.

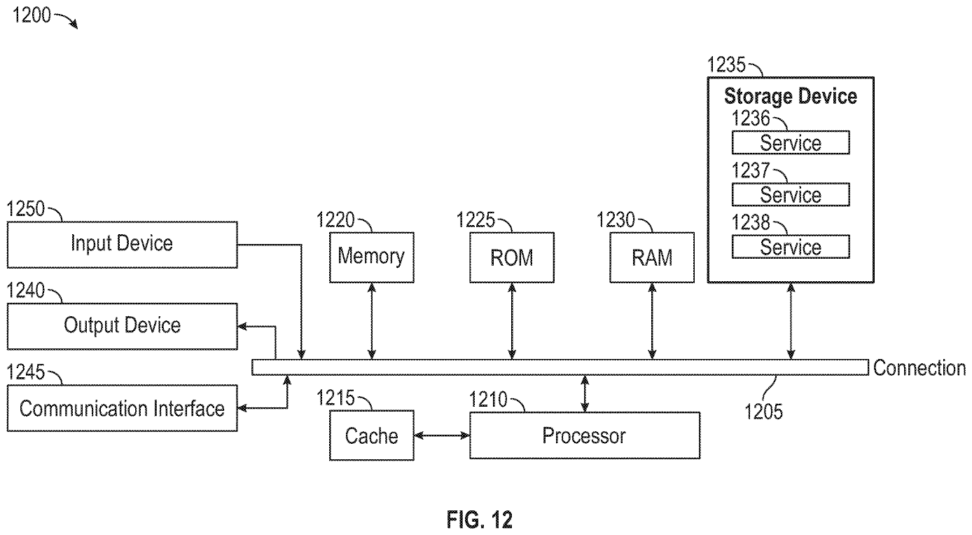

FIG. 12 illustrates an example computing system 1200 of an example robot configured to implement various techniques described herein. Components of computing system 1200 are shown in electrical communication with each other using connection 1205, such as a bus. The example computing system 1200 includes a processing unit (CPU or processor) 1210 and computing device connection 1205 that couples various computing device components including computing device memory 1220, such as read only memory (ROM) 1225 and random-access memory (RAM) 1230, to processor 1210.

Computing system 1200 can include a cache of high-speed memory connected directly with, in close proximity to, or integrated as part of processor 1210. Computing system 1200 can copy data from memory 1220 and/or the storage device 1235 to cache 1215 for quick access by processor 1210. In this way, the cache can provide a performance boost that avoids processor 1210 delays while waiting for data. These and other modules can control or be configured to control processor 1210 to perform various actions. Other computing device memory 1220 may be available for use as well. Memory 1220 can include multiple different types of memory with different performance characteristics. Processor 1210 can include any general-purpose processor and a hardware or software service, such as service 1 1232, service 2 1234, and service 3 1236 stored in storage device 1235, configured to control processor 1210 as well as a special-purpose processor where software instructions are incorporated into the processor design. Processor 1210 may be a self-contained system, containing multiple cores or processors, a bus, memory controller, cache, etc. A multi-core processor may be symmetric or asymmetric.

To enable user interaction with the computing system 1200, input device 1250 can represent any number of input mechanisms, such as a microphone for speech, a touch-sensitive screen for gesture or graphical input, keyboard, mouse, motion input, speech and so forth. Output device 1240 can also be one or more of a number of output mechanisms known to those of skill in the art, such as a display, projector, television, speaker device, etc. In some instances, multimodal computing devices can enable a user to provide multiple types of input to communicate with computing system 1200. Communication interface 1245 can generally govern and manage the user input and computing device output. There is no restriction on operating on any particular hardware arrangement and therefore the basic features here may easily be substituted for improved hardware or firmware arrangements as they are developed.

Storage device 1235 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 1225, read only memory (ROM) 1225, and hybrids thereof. Storage device 1235 can include services 1236, 1234, 1236 for controlling processor 1210. Other hardware or software modules are contemplated. Storage device 1235 can be connected to the computing device connection 1205. In one aspect, a hardware module that performs a particular function can include the software component stored in a computer-readable medium in connection with the necessary hardware components, such as processor 1210, connection 1205, Output device 1240, and so forth, to carry out the function.

While the operations of the methods described herein in a particular order, many of the operations can be performed in parallel or in a different order as can be envisioned by one of ordinary skill in the art in light of this disclosure.

Additionally, aspects of the application are described with reference to specific aspects thereof, but those skilled in the art will recognize that the application is not limited thereto. Thus, while illustrative aspects of the application have been described in detail herein, it is to be understood that the disclosure may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

What is claimed is:

1. An automated system for separating mail transport equipment, the system comprising:
a receiving parcel belt conveyor onto which mail transport equipment (MTE) is deposited;
a plurality of additional parcel belt conveyors arranged in series, each of the plurality of additional parcel belt conveyors angled relative to one another at a predetermined angle;
a sortation conveyor onto which the MTE is deposited after exiting an end one of the plurality of additional parcel belt conveyors, wherein the sortation conveyor is configured to further separate the MTE and sort the MTE;
a plurality of sorting line conveyors coupled to the sortation conveyor, wherein each of the sorting line conveyors is configured to receive a predetermined size of MTE conveyed from the sortation conveyor;
a scanning device operable to determine if a conveyed MTE has one or more unapproved material thereon;
a plurality of picking robots configured to pick up a single one of the conveyed MTE, wherein each of the plurality of picking robots is assigned to one of the plurality of sorting line conveyors;
a plurality of stacking stations configured to receive a picked MTE from a respective one of the plurality of picking robots, whereon the conveyed MTE is stacked by the respective one of the plurality of picking robots into stacks of MTE on each of the stacking stations; and
a plurality of stacking station conveyors corresponding to each of the plurality of stacking stations, the plurality of stacking station conveyors operable to transport each of the stacks of MTE to an outflow conveyor.

2. The automated system of claim 1, further comprising one or more dumpers, wherein the dumpers contain the MTE.

3. The automated system of claim 2, wherein the one or more dumpers are operable to receive MTE sleeves contained within a gaylord.

4. The automated system of claim 1, wherein the MTE comprises sleeves.

5. The automated system of claim 1, wherein each of the receiving parcel belt conveyor and the plurality of additional parcel belt conveyors are angled at a different angle relative to ground as compared to others of the plurality of parcel belt conveyors.

6. The automated system of claim 5, wherein at least one of the plurality of parcel belt conveyors is angled at a negative angle.

7. The automated system of claim 6, wherein two or more of the plurality of additional parcel belt conveyors are angled at a negative angle, and the two or more negative angle parcel belt conveyors have an angle that is less in magnitude than at least one of a remainder of the plurality of additional parcel belt conveyors.

8. The automated system of claim 6, wherein two or more of the plurality of additional parcel belt conveyors are angled at a negative angle, and at least two of a remainder of the plurality of additional parcel belt conveyors are angled at a positive angle and a magnitude of at least one of the remainder of the plurality of additional parcel belt conveyors is greater than a magnitude of each of the two or more negative angle parcel belt conveyors.

9. The automated system of claim 6, wherein each of the plurality of parcel belt conveyors is the same length.

10. The automated system of claim 1, wherein the plurality of sorting line conveyors convey the MTE into respective pick bins, and wherein each robot of the plurality of robots is configured to respectively pick the MTE from the respective pick bins.

11. The automated system of claim 10, wherein the sortation conveyor comprises a plurality of individually operable rollers configured to further singulate the MTE received from the plurality of additional parcel belt conveyors and to direct each MTE to a respective one of the plurality of sorting line conveyors based on a size or type of the MTE, and wherein the plurality of sorting line conveyors includes three sorting line conveyors, each sorting line conveyor operable to receive a species of MTE from the sortation conveyor.

12. The automated system of claim 1, further comprising:
a label cancelation conveyor configured to receive a labeled MTE determined to have the one or more unapproved material thereon by the scanning device, from one of the plurality of picking robots;
a label cancelation system configured to receive the labeled MTE, the label cancelation system including
a plurality of inspection cameras configured to determine a location of the one or more unapproved material; and
at least one material covering device operable to place a non-transparent cover over each of the one or more unapproved material to render the labeled MTE a label-canceled MTE; and
a return conveyor configured to return the label-canceled MTE to the end one of the plurality of additional parcel belt conveyors.

13. The automated system of claim 12, wherein the plurality of inspection cameras comprises:
a top inspection camera operable to view a top of the MTE to determine presence of unapproved material on a first side of the labeled MTE; and
a bottom inspection camera arranged to view an opposite side of the labeled MTE as compared to the top inspection camera, wherein the bottom inspection camera is operable to determine the presence of unapproved material on the labeled MTE,
wherein the at least one material covering device includes a first material covering device paired with the top inspection camera and a second material covering device paired with the bottom inspection camera, the first and second material covering devices operable to respectively apply labels to unapproved material identified respectively on the first and opposite sides of the labeled MTE.

14. The automated system of claim 13, wherein the material covering device applies one of an ink covering or a blank label covering.

15. The automated system of claim 14, wherein the one or more unapproved material includes a barcode, a QR code, a 2-D code, and/or a 3-D code.

16. The automated system of claim 1, further comprising a palletizing robot positioned downstream of the outflow conveyor and operable to transfer the stacks of MTE from the outflow conveyor onto a pallet, and a stretchwrap station positioned downstream of the palletizing robot and configured to apply wrap to the pallet.

17. The automated system of claim 1, wherein two or more of the plurality of additional parcel belt conveyors are angled at a negative angle relative to ground, and wherein adjacent ones of the plurality of additional parcel belt conveyors are spaced from one another such that refuse deposited on the plurality of additional parcel belt conveyors separates from the MTE as the MTE transitions between the adjacent ones of the plurality of additional parcel belt conveyors.

18. An automated system for processing mail transport equipment (MTE), the system comprising:
a receiving conveyor configured to receive MTE deposited from a bulk container;
a plurality of parcel belt conveyors arranged in series downstream of the receiving conveyor in an alpine configuration, wherein at least three parcel belt conveyors of the plurality of parcel belt conveyors are arranged such that at least one of the at least three parcel belt conveyors is oriented as a declining parcel belt conveyor defining a negative angle relative to ground, and wherein adjacent parcel belt conveyors of the plurality of parcel belt conveyors are operated at different speeds to reduce overlap between adjacent mail transport equipment;
a sortation conveyor positioned downstream of the plurality of parcel belt conveyors and configured to direct each MTE to a selected one of a plurality of sorting line conveyors based on a species of MTE;
a plurality of picking robots, each picking robot associated with a respective one of the plurality of sorting line conveyors and configured to pick up a single MTE from the respective sorting line conveyor, each picking robot operatively coupled with a scanning device configured to detect unapproved material on the single MTE;
a label cancellation system configured to receive MTE identified as including the unapproved material, the label cancellation system configured to cover the unapproved material;
a return conveyor coupled to the label cancellation system and configured to return label-cancelled MTE to the plurality of parcel belt conveyors;
a plurality of stacking stations, each stacking station associated with a respective one of the plurality of picking robots and configured to receive the MTE from the respective picking robot to form a stack of MTE; and
an outflow conveyor positioned downstream of the plurality of stacking stations and configured to transport the stack of MTE toward a palletizing system.

19. A method of sorting mail transport equipment (MTE), the method comprising:
depositing MTE from a bulk container onto at least one receiving conveyor;
singulating the MTE by conveying the MTE along a plurality of conveyors arranged in series, wherein at least two conveyors of the plurality of conveyors are angled relative to one another or operated at different speeds to reduce overlap between adjacent MTE;
identifying, by one or more sensors, a type of each singulated MTE;
directing, by a multi-directional sortation conveyor, each identified MTE to a respective sorting line conveyor based on the identified type of the MTE;
detecting, by one or more scanning devices, whether the MTE includes unapproved material;
diverting MTE including the unapproved material to a label cancellation system;
covering, obscuring, or removing the unapproved material from the diverted MTE; and
stacking sorted MTE from the respective sorting line conveyors at respective stacking stations.

20. The method of claim 19, wherein singulating the MTE comprises conveying the MTE along the plurality of conveyors arranged successively at alternating angles relative to ground, wherein at least one conveyor of the plurality of conveyors is arranged at a positive angle relative to ground and at least one other conveyor of the plurality of conveyors is arranged at a negative angle relative to ground, and wherein successive conveyors of the plurality of conveyors are operated at different speeds such that, as the MTE falls from one conveyor to a successive conveyor, individual MTE contacting the successive conveyor at different times are advanced at different rates to increase separation between adjacent MTE.
